(19) United States
(12) Patent Application Publication
(10) Pub. No.: US 2012/0011435 A1
(43) Pub. Date: Jan. 12, 2012

(54) Display apparatus and display method

(75) Inventors: Shoji Koarai, Osaka (JP); Yoshihiro Mizoguchi, Osaka (JP)

(73) Assignee: Sharp Kabushiki Kaisha, Osaka (JP)

(21) Appl. No.: 13/135,555

(22) Filed: Jul. 8, 2011

(30) Foreign Application Priority Data
Jul. 9, 2010 (JP) JP2010-157089

(51) Int. Cl. G06F 3/14

(52) U.S. Cl. 715/274

(57) ABSTRACT

Image data for a preview image corresponding to a plurality of pages of a document is generated in each page. Display of the preview image based on the image data that has been generated is initiated, before the image data generation for the preview images in all pages is completed. The preview image is promptly displayed without keeping a user waiting until the image data generation for the image previews in all pages corresponding to the plurality of pages of the document is completed.

### CROSS-REFERENCE TO RELATED APPLICATION

This non-provisional application claims priority under 35 U.S.C. §119(a) on Patent Application No. 2010-157089 filed in Japan on Jul. 9, 2010, the entire contents of which are hereby incorporated by reference.

### BACKGROUND

1. Technical Field

The present invention relates to an apparatus and a method for displaying a preview image corresponding to output data.

2. Description of Related art

For example, in order to output a document such as writing, images, and so on, which a user creates upon the activation of application in a personal computer, to an image formation apparatus such as a printer and a multi-function peripheral, a printer driver is installed in the personal computer

By utilizing the printer driver, an output is visible to the user in advance according to the type of output data displayed on a display section in the personal computer. The so-called preview function has come into wide use.

Japanese Patent Application Laid-Open No.2007-157121 also discloses an information processing apparatus for saving input document data as intermediate data and then displaying a preview image on a display section based on the document data having been saved.

### SUMMARY

However, the information processing apparatus disclosed in Japanese Patent Application Laid-Open No. 2007-157121 is configured to generate drawing data as intermediate data for image display in each page of the document data to be inputted and initiate display of the preview images after drawing data in the final page is generated. The user unfortunately has to wait a period of time for the display of the preview images until the generation of drawing data in the final page is completed.

In view of such conditions described above, an object of the present invention is to provide a display apparatus and a display method which can promptly display a preview image without keeping a user waiting until completing the image data generation for the preview images in all pages by including an image display section which initiates display of the preview image based on already generated image data before image data generation in all pages is completed.

A display apparatus according to the present invention is a display apparatus for generating image data in each page for preview image corresponding to output data of a plurality of pages and displaying a preview image based on the image data, comprising an image display section for initiating display of the preview image based on already generated image data before image data generation in all pages is completed.

The display apparatus of the present invention generates the image data in each page for preview image corresponding to the output data. Before the image data generation for the preview image in all pages is completed, the image display section initiates the display of the preview image based on the already generated image data for preview image.

In the display apparatus according to the present invention, the image display section displays the preview image based on the image data whenever each image data is generated.

In the present invention, before the image data generation for the preview images relating to the output data of all pages is completed, whenever each image data is generated, the image display section displays the preview image based on the generated image data.

In the display apparatus according to the present invention, the image display section displays a plurality of preview images based on a plurality of image data whenever the plurality of image data is generated.

In the present invention, before the image data generation for the preview images relating to the output data of all pages is completed, whenever the plurality of image data is generated, the image display section displays the plurality of preview images based on the plurality of generated image data.

In the display apparatus according to the present invention, the preview image is displayed in a form of a display pane surrounding the preview image, and the image display section displays information of display processing inside the display pane prior to display of the preview image.

In the present invention, when the image data generation for the preview image to be displayed inside a predetermined display pane is not completed, the image display section displays the information of display processing inside the display pane.

A display method according to the present invention is a display method for generating image data for preview image corresponding to output data of a plurality of pages and displaying a preview image based on the image data, comprising steps of: generating the image data in each page; judging whether image data generation in each page is completed or not; and displaying the preview image based on the image data whenever each image data is generated, according to the judgment result in the judging step.

In the present invention, the image data for the preview image corresponding to the output data is generated in each page. Under these circumstances, it is judged whether the image data generation in each page is completed or not. Whenever each image data is generated, the preview image is displayed based on each generated image data prior to completing the image data generation for the preview images in all pages.

A display method according to the present invention is a display method for generating image data for preview image corresponding to output data of a plurality of pages and displaying a preview image based on the image data, comprising steps of: generating the image data in each page; judging whether image data generation in each plurality of pages is completed or not; and displaying a plurality of preview images based on a plurality of image data whenever the plurality of image data is generated, according to the judgment result in the judging step.

In the present invention, the image data for the preview image corresponding to the output data is generated in each page. Under these circumstances, it is judged whether the image data generation in each plurality of pages is completed or not. Whenever each plurality of image data is generated, the plurality of preview images are displayed based on the plurality of generated image data prior to completing the image data generation for the preview images in all pages.

In the display of the preview image corresponding to the output data in accordance with the present invention, since the image display section initiates the display of the preview image based on the already generated image data prior to completing the image data generation for the preview images in all pages, the present invention promptly displays the preview image without keeping the user waiting until completing the image data generation for the preview images in all pages.

The above and further objects and features of the invention will more fully be apparent from the following detailed description with accompanying drawings.

### BRIEF DESCRIPTION OF THE SEVERAL VIEWS OF THE DRAWINGS

FIG. 1 is a functional block diagram illustrating an essential configuration of a personal computer according to Embodiment 1 of the present invention;

FIG. 2 is a flowchart showing a method for displaying preview images in the personal computer according to Embodiment 1 of the present invention;

FIG. 3 is an exemplary view illustrating an example of display of preview images in the personal computer according to Embodiment 1 of the present invention;

FIG. 4 is an exemplary view illustrating another example of display of preview images in the personal computer according to Embodiment 1 of the present invention;

FIG. 5 is a functional block diagram illustrating an essential configuration of a preview application according to Embodiment 2 of the present invention;

FIG. 6 is a flowchart showing a method for displaying preview images in a personal computer according to Embodiment 2 of the present invention; and

FIG. 7 is a functional block diagram illustrating an essential configuration of a personal computer according to Embodiment 3 of the present invention.

### DETAILED DESCRIPTION

The following description will explain an example in which a personal computer is applied in a display apparatus, a display method and a computer program according to an embodiment of the present invention.

### Embodiment 1

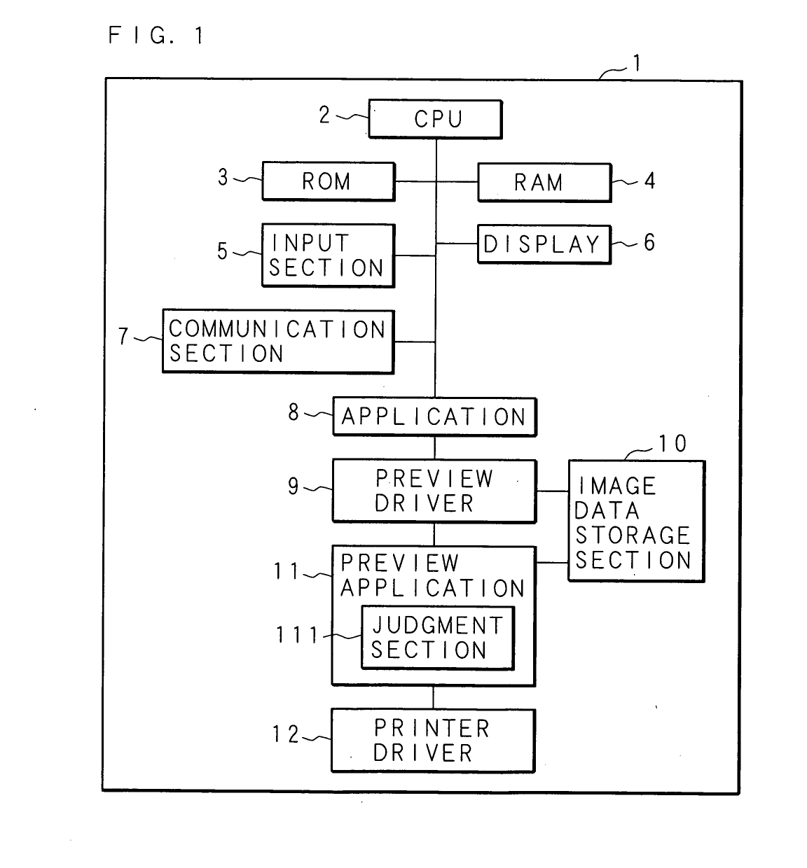

FIG. 1 is a functional block diagram illustrating an essential configuration of a personal computer 1 according to Embodiment 1 of the present invention. For example, the personal computer 1 is connected to a multi-function peripheral (not illustrated) through a LAN, the multi-function peripheral outputs an image based on document data (output data) created by the personal computer 1.

For example, the personal computer 1 utilizes the Microsoft Windows® as an OS. Additionally, the personal computer 1 has a CPU 2, a ROM 3, a RAM 4, an application 8, a preview driver 9, a preview application 11, a printer driver 12, an input section 5, a display 6, a communication section 7, and an image data storage section 10.

The ROM 3 stores in advance a variety of control programs, text data for later mentioned notification, standard page number for determining a completion of the image data generation, and so on. The RAM 4 stores data temporally so the data is readable regardless of the storage order and storage location. Additionally, the RAM 4 stores a program read from the ROM 3, a variety of data that is generated by the execution of the program, and a variety of data that is received from an external section.

The CPU 2 loads a variety of control programs stored in the ROM 3 onto the RAM 4, and then controls a variety of above-described hardware sections by executing the control programs. The whole apparatus is operated as the personal computer 1 according to Embodiment 1 of the present invention.

The application 8 is an application program providing functions of text editing such as word processing, paint, presentation, and so on. Document data created by the application 8 is provided to the preview driver 9 via an interface equipped in the OS.

The input section 5 has a keyboard, a mouse, and so on a user inputs data via the input section 5, and document data is created by the application 8.

For example, the display 6 is comprised of a liquid crystal display. The display 6 displays a preview image based on image data for preview image generated by the preview driver 9, and then displays a setting reception screen according to the later-mentioned preview application 11.

For example, the communication section 7 has a networking card, a modem, etc for transmitting print data to the multi-function peripheral.

The preview driver 9 is activated when the creation of a document by the application 8 is completed and a printing (output) instruction is accepted from the user. After that, the preview driver 9 generates image data (intermediate file) for preview image corresponding to the document. For example, the preview driver 9 generates the image data for preview image in each page of the document by the page order corresponding to each page.

Specifically, the preview driver 9 generates the image data for preview image in each page according to the document data from the application 8 and information from the printer driver 12. For example, the image data is EMF (Enhance Meta File) with superior reproducibility, dissemination, and so on. The metadata (such as paper size, resolution, direction, etc) relating to the document data and printing of the document data is included in the image data. The image data (the intermediate file) for preview image may be XPS data. The image data storage section 10 stores the image data, which is generated by the preview driver 9.

The preview application 11 (the image display section) displays the preview image on the display 6 and improves visual recognition of the printing status for the user along with displaying the setting reception screen such as a user interface for accepting settings of the printing conditions (such as number of copies, duplex/simplex printing, N-up printing, magnified printing, and so on) and post-printing processing conditions (such as bookbinding, stapling, and so on) requested by the user. In addition, the preview application 11 modifies the image data for preview image based on the accepted settings, and displays the preview image based on the modified image data on the display 6.

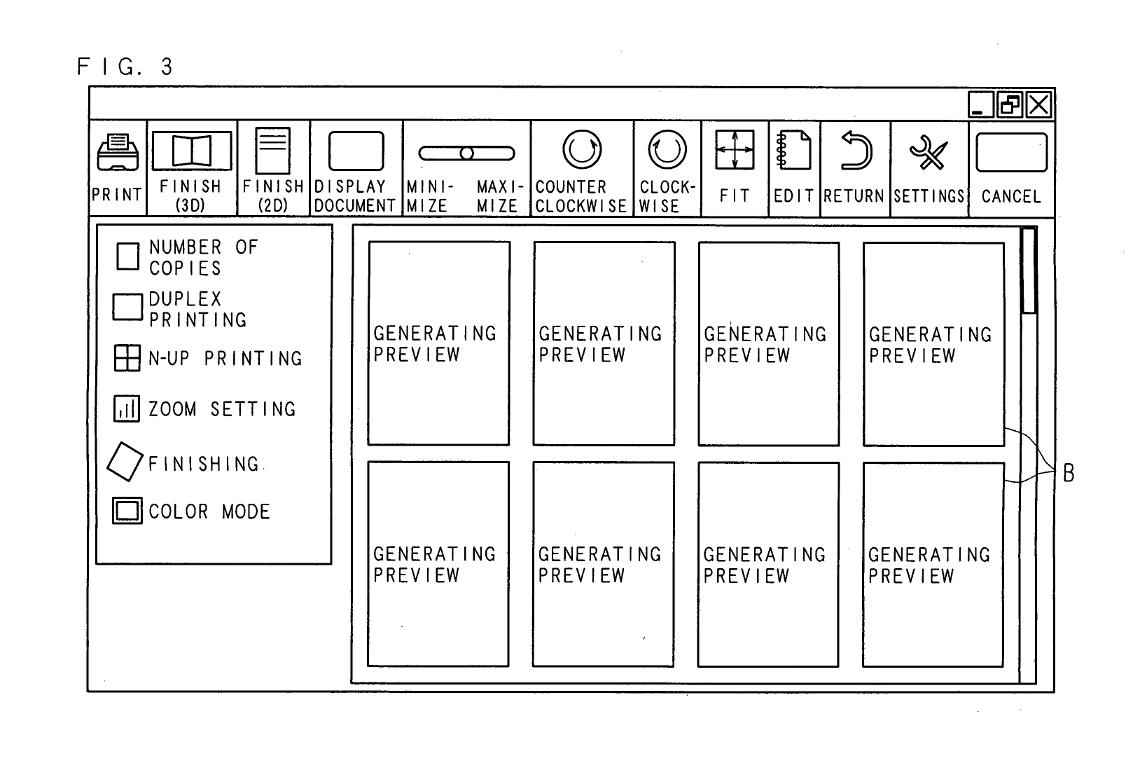

In the setting reception screen, the “Cancel” soft key is provided (refer to the later-mentioned FIG. 3). The Display of the preview image is cancelled when the user operates the “Cancel” soft key. For example, in a document of 100 pages, when the user operates the “Cancel” soft key while the preview image corresponding to 50-th page is being displayed, the display of the preview images after the 50-th page are cancelled.

Accordingly, even when a modification is made, the present invention can promptly display the preview image reflected from the post-printing processing conditions as well as the printing conditions; it can improve the user's visibility.

Whenever the preview driver 9 generates each image data, the preview application 11 displays the preview image on the display 6 based on the generated image data. Namely, the preview application 11 initiates the display of the preview image based on the image data having been already generated before the image data generation in all pages of the document is completed. In addition, the preview application 11 transmits the document data, printing conditions, and post-printing processing conditions to the printer driver 12, and instructs transmission to the multi-function peripheral.

For example, the preview application 11 transfers the image data (the EMF data) to a Win32API, which is drawing means provided by the OS, and causes the Win32API to display output of the EMF data. After that, the preview image is displayed on the display 6 based on the image data generated by the preview driver 9. Additionally, the setting reception screen is displayed on the display 6.

Additionally, the preview application 11 has a judgment section 111. The judgment section 111 judges whether the image data generation is completed or not in each page when the preview driver 9 generates the image data. The judgment section 111 performs the judgment by monitoring the image data generated by the preview driver 9 is stored into the data image storage section 10. According to the judgment result of the judgment section 111, since the preview application 11 displays the preview image on the display 6 one by one based on the image data, whenever the image data for preview image in each page of the document is generated, the display of the preview image can be initiated before the image data generation in all pages is completed.

The preview application 11 transmits the EMF data to the printer driver 12. When the preview application 11 receives the printing conditions and post-printing processing conditions through the setting reception screen, the review application 11 transmits these received conditions to the printer driver 12.

The printer application 12 transmits the print data to the multi-function peripheral. The print data is obtained by converting the EMF data (the intermediate file), which is acquired from the preview application 11, to PCL data that is printable by the multi-function peripheral. The multi-function peripheral receives the PCL data and performs the printing process of image relating to the document data onto a sheet based on the printing conditions and post-printing processing conditions.

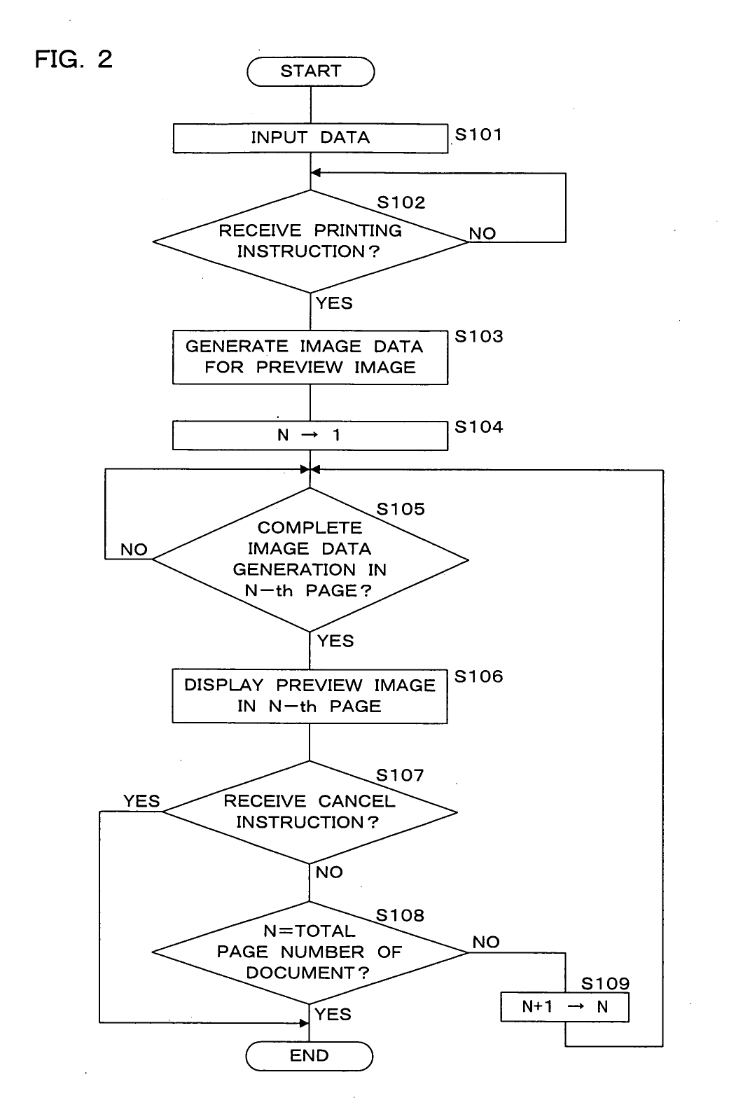

FIG. 2 is a flowchart showing a method for displaying preview images in the personal computer 1 according to Embodiment 1 of the present invention.

For example, the user operates the input section 5 of the personal computer 1; data is inputted through the input section 5 (Step S101). A document is created by the application 8 based on the input data. For convenience, the following description explains a case of creating an 8-page document.

The CPU 2 judges whether or not the printing instruction of document is received according to signals from the input section 5, coordinates on the screen in the display 6, and so on (Step 102). For example, “Printing” soft key is arranged at a predetermined position on the screen. The CPU 2 monitors the operation of “Printing” soft key according to the signals from the input section 5, the coordinates on the screen in the display 6, and so on.

While the user is still creating a document, the “Printing” soft key is not operated; therefore, the CPU 2 judges that the printing instruction of a document is not received (Step 5102: NO). The procedure is waited until the CPU 2 receives the printing instruction.

On the other hand, once the user finishes creating a document and instructs printing of document by operating the “Printing” soft key with a mouse as an example, the CPU2 judges that the printing instruction of document is received (Step S102: YES), and the preview driver 9 is activated.

The preview driver 9 generates the image data (the EMF Data) in each page for preview image relating to the document based on the document data from the application 8 and the information from the printer driver 12. The EMF Data includes the document data and metadata relating to the printing of the document. The image data storage section 10 stores the generated image data.

Next, the judgment section 111 of the preview application 11 assigns a value 1 to “N” (Step S104), then the judgment section 111 judges whether the image data generation for preview image in the N-th page of the document is completed or not (Step S105). In this judgment, as described above, the judgment section 111 monitors whether the image data for preview image in the N-th page is stored or not in the image data storage section 10.

When the judgment section 111 judges that the image data generation for the preview image in the N-th page is not completed (Step S105: NO), the judgment section 111 repeats the judgment until the completion. On the other hand, when the judgment section 111 judges that the image data generation for the preview image in the N-th page is completed (Step S105: YES), the preview application 11 displays the preview image on the display 6 based on the image data generated in the N-th page (Step S106).

Specifically, the preview application 11 causes the display 6 to display the setting reception screen, and then the preview image is displayed in the setting reception screen. FIG. 3 is an exemplary view illustrating an example of the display of preview images in the personal computer 1 according to Embodiment 1 of the present invention. Initially, the preview application 11 displays several display panes B corresponding to the total page number of a document. Next, the preview application 11 displays the text “GENERATING PREVIEW” inside the display pane B to notify the user of information indicating that the preview application 11 is currently processing the preview image generation. For example, when the image data generation in the first page of a document is completed, the preview application 11 reads image data in the first page from the image data storage section 10, and then the preview application 11 displays the preview image in the first page based on the read image data in the corresponding display pane B. Namely, each preview image is being displayed in the form of each display pane B surrounding the preview image respectively.

Hereafter, the CPU 2 judges whether or not to receive the instruction for canceling display of preview image by monitoring the “Cancel” soft key in the setting reception screen (Step S107).

When the CPU 2 judges that the instruction for canceling display of preview image is received (Step S107: YES), the CPU 2 instructs the preview application 11 to cancel display of preview image, and terminates the procedure.

On the other hand, when the CPU 2 judges that the instruction for canceling display of preview image is not received (Step S107: NO), the judgment section 111 judges whether or not the “N” reaches up to the total page number of document; namely “8” (Step S108).

When the judgment section 111 judges that the “N” reaches up to the total page number of document (Step S108: YES), the CPU 2 recognizes that preview images in all pages are displayed, and then the CPU 2 terminates the procedure.

Additionally, when the judgment section 111 judges that the “N” does not reach up to the total page number of document (Step S108: NO), the new “N” is assigned by adding “1” to the current “N” (Step S109), and then the procedure is returned to Step S105. Hereafter, the procedure from Step S105 to Step S109 is repeated until preview images in all pages of document are displayed.

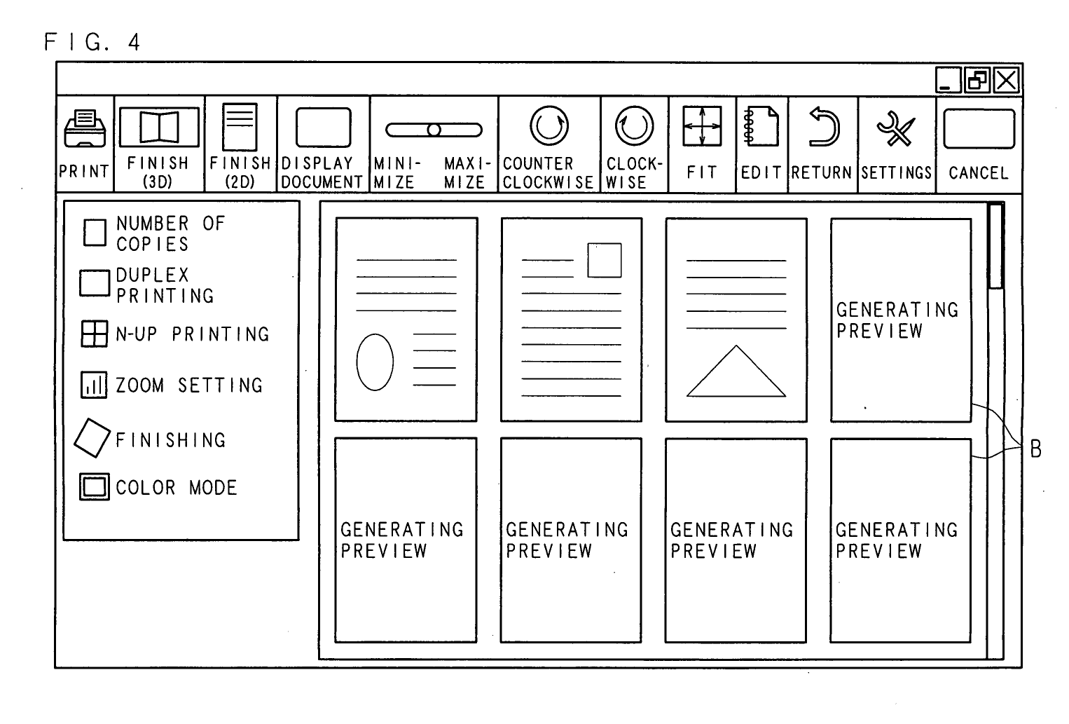

FIG. 4 is an exemplary view illustrating another example of display of preview images in the personal computer 1 according to Embodiment 1 of the present invention. For example, when the “N” is “3” in the Step S106, the preview images up to the 3rd page of the document are displayed. The text “GENERATING PREVIEW” is displayed inside the display panes B in which the preview images in remaining pages are to be displayed

The display apparatus according to Embodiment 1 of the present invention has the configuration described above. The display apparatus can promptly display the preview image without keeping the user waiting until the image data generation in all pages of document is completed.

### Embodiment 2

The configuration of a personal computer 1 according to Embodiment 2 of the present invention is similar to that of the personal computer 1 according to Embodiment 1, however, the configurations of preview application 11 are different.

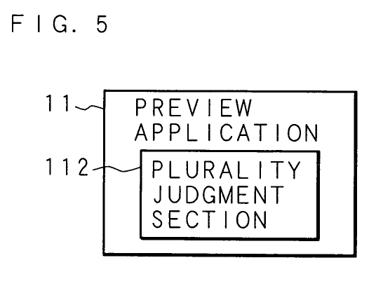

FIG. 5 is a functional block diagram illustrating an essential configuration of the preview application 11 according to Embodiment 2 of the present invention. In Embodiment 2 of the present invention, the preview application 11 in the personal computer 1 has a plurality judgment section 112. When the preview driver 9 generates image data, the plurality judgment section 112 judges whether the image data generation in each “plurality” of pages is completed or not.

For example, when the “plurality” is “2”, since the plurality judgment section 112 judges whether the image data generation in each 2-page is completed or not, the plurality judgment section 112 judges whether the image data generation in the 2nd page, 4th page, 6th page . . . of the document is completed or not. Specifically, the plurality judgment section 112 executes this judgment by monitoring “2N” pieces of image data generated by the preview driver 9 is stored into the image data storage section 10.

According to the judgment result of the plurality judgment section 12, whenever generating the image data in the “plurality” of pages of the document, since the preview application 11 displays the plurality of preview images on the display 6 respectively according to the plurality of image data, the display of the preview image can be initiated before the image data generation in all pages is completed.

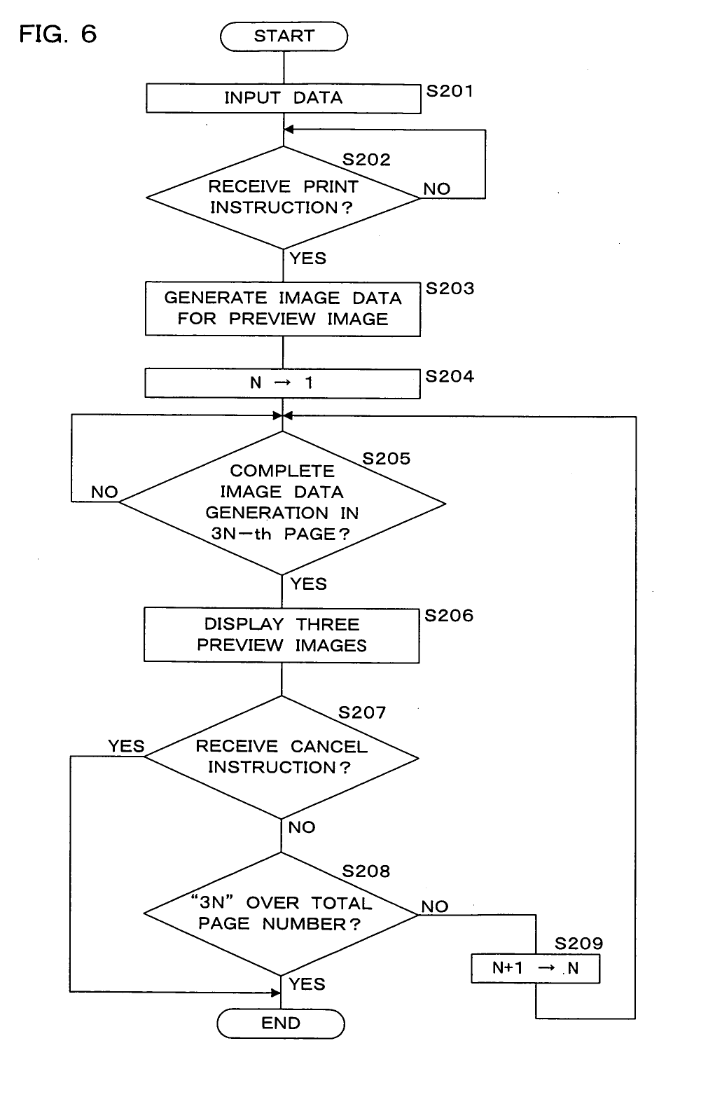

FIG. 6 is a flowchart showing a method for displaying preview images in the personal computer 1 according to Embodiment 2 of the present invention. For convenience, the following example describes that the plurality judgment section 112 judges the completion of the image data generation in each 3-page.

For example, the user operates the input section 5 of the personal computer 1; data is inputted through the input section 5 (step S201). A document is created by the application 8 based on the input data. For convenience, the following description explains a case of creating an 8-page document.

The application 8 judges whether or not the printing instruction of document is received according to signals from the input section 5, coordinates on the screen in the display 6, and so on (Step 202). When the application 8 judges that the printing instruction of document is not received (Step S202: NO), the procedure is waited until the printing instruction is received.

On the other hand, when the application 8 judges that the printing instruction of document is received (Step S202: YES), the preview driver 9 is activated. Next, the preview driver 9 generates the image data (the EMF data) in each page for preview image relating to the document based on the document data from the application 8 and the information from the printer driver 12 (Step S203). The image data storage section 10 stores the generated image data.

After that, the plurality judgment section 112 of the preview application 11 initially assigns a value “1” to “N” (Step S204), and then judges whether the image data generation for preview image in the “3N”-th page of the document is completed or not (Step S205). This judgment is executed as above-described, the detail description of the judgment is omitted.

When the plurality judgment section 112 judges that the image data generation for the preview image in the “3N”-th page is not completed (Step S205: NO); the plurality judgment section 112 repeats the judgment until the completion. On the other hand, when the plurality judgment section 112 judges that the image data generation for the preview image in the “3N”-th page is completed (Step S205: YES), the preview application 11 displays three preview images on the display 6 based on the generated 3-page image data (Step S206).

Specifically, since the plurality judgment section 112 judges whether the image data generation in the “3N”-th page of the document is completed or not, it judges the completion of the image data generation in the 3rd page and 6th page of the document. For example, when the plurality judgment section 112 judges that the image data generation in the 6th page is completed, the image data storage section 10 is in a status of storing image data for three preview images corresponding to the 4th page to 6th page of the document. The preview application 11 reads these three pieces of image data from the image data storage section 10 and displays three preview images based on the three pieces of image data.

Hereafter, the CPU 2 judges whether or not to receive the instruction for canceling display of the preview image by monitoring the “Cancel” soft key in the setting reception screen (Step S207). When the CPU 2 judges that the instruction for canceling display of preview image is received (Step S207: YES), the CPU 2 instructs the preview application 11 to cancel display of preview image and terminate the procedure.

On the other hand, when the CPU 2 judges that the instruction for canceling display of preview image is not received (Step S207: NO), the plurality judgment section 112 judges whether the “3N” is over the total page number of document or not; namely over “8” (Step S208).

When the plurality judgment section 112 judges that the “3N” is not over the total page number of document (Step S208: NO), the new “N” is assigned by adding “1” to the current “N” (Step S209), and then the procedure is returned to Step S205.

On the other hand, during the time of returning the procedure from Step S209 to Step S205, a step is set up for judging whether the “3N” (the new “N” is multiplied by “3”) is over the total page number of the document or not (not illustrated). When it is judged that the “3N” is over the total page number of the document, the plurality judgment section 112 judges whether the image data generation for preview image in the final page of the document is completed or not in Step S205, the specified number of preview images may be displayed on the display 6 in Step S206 based on the specified number of image data that have been generated until the final page of the document.

When the plurality judgment section 112 judges that the “3N” is over the total page number of the document; for instance, when N is assigned by a value of “3”, then the “3N” becomes a value of “9” so it is over the total page number of the document, the CPU 2 recognizes that the preview images in all pages are all displayed and terminates the procedure.

The same parts as in Embodiment 1 are designated with the same reference numbers, and detailed explanation thereof is omitted.

### Embodiment 3

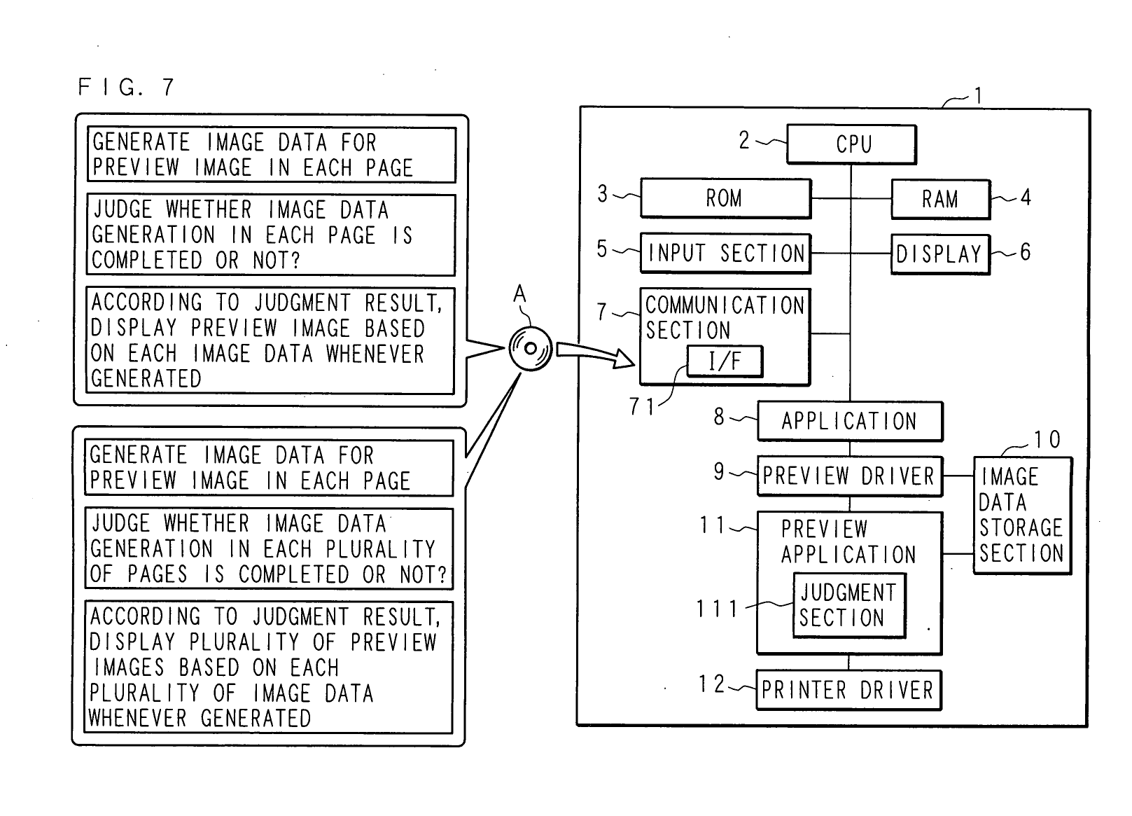

FIG. 7 is a functional block diagram illustrating an essential configuration of the personal computer according to Embodiment 3 of the present invention. The personal computer 1 of Embodiment 3 is configured so that a computer program for operations is capable of being provided by a removable recording medium A, such as a CD-ROM, through an I/F 71. Further, in the personal computer 1 according to Embodiment 3, the computer program is downloadable from an external device (not illustrated) through a communication section 7. These situations are described below.

The personal computer 1 of Embodiment 3 comprises an external (or internal) recording medium reader device (not shown). A removable recording medium A, which stores a program for generating image data for preview image in each page, judging whether the image data generation in each page is completed or not, and displaying the preview image based on each image data whenever each image data is generated according to the judgment result; alternatively, a program for generating image data for preview image in each page, judging whether the image data generation in each plurality of pages is completed or not, and displaying a plurality of preview images based on the plurality of image data whenever a plurality of image data is generated according to the judgment result, is inserted into the recording medium reader device, and, for example, a CPU 2 installs the program in a ROM 3. The program is loaded into a RAM 4 and executed. Consequently, it functions as the personal computer 1 of Embodiment 1 of the present invention.

The recording medium may be a so-called program medium, and may be a medium of tape type, disk type, or card type as well as a semiconductor memory or the like that stores a program code in a fixed manner. The medium of tape type may be a magnetic tape, a cassette tape, or the like. The medium of disk type may be a magnetic disk, an optical disk, or the like. The magnetic disk may be a flexible disk, a hard disk, or the like. The optical disk may be a CD-ROM, an MO, an MD, a DVD, or the like. The medium of card type may be an IC card (including a memory card), an optical card, or the like. The semiconductor memory may be a mask ROM, an EPROM, an EEPROM, a flash ROM, or the like.

The recording medium may be a medium dynamically storing a program code such that the program code is downloaded from a network through the communication section 7. Here, when the program is to be downloaded through a communication network as described here, a program for download may be stored in advance in the main apparatus or alternatively may be installed from another recording medium. Here, the present invention may be implemented in the form of a computer data signal in which the program code is implemented by electronic transmission and the implemented program code is embedded in carrier waves.

The same parts as in Embodiment 1 are designated with the same reference numbers, and detailed explanation thereof is omitted.

As this description may be embodied in several forms without departing from the spirit of essential characteristics thereof, the present embodiments are therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A display apparatus for generating image data in each page for preview image corresponding to output data of a plurality of pages and displaying a preview image based on the image data, comprising:
an image display section for initiating display of the preview image based on already generated image data before image data generation in all pages is completed.

2. The display apparatus, according to claim 1, wherein the image display section displays the preview image based on the image data whenever each image data is generated.

3. The display apparatus, according to claim 1, wherein the image display section displays a plurality of preview images based on a plurality of image data whenever the plurality of image data is generated.

4. The display apparatus, according to claim 1, wherein the preview image is displayed in a form of a display pane surrounding the preview image, and the image display section displays information of display processing inside the display pane prior to display of the preview image.

5. A display method for generating image data for preview image corresponding to output data of a plurality of pages and displaying a preview image based on the image data, comprising steps of:
generating the image data in each page;
judging whether image data generation in each page is completed or not; and
displaying the preview image based on the image data whenever each image data is generated, according to the judgment result in the judging step.

6. A display method for generating image data for preview image corresponding to output data of a plurality of pages and displaying a preview image based on the image data, comprising steps of:
generating the image data in each page;
judging whether image data generation in each plurality of pages is completed or not; and
displaying a plurality of preview images based on a plurality of image data whenever the plurality of image data is generated, according to the judgment result in the judging step.

7. A non-transitory recording medium recording a computer program for causing a computer to generate image data for preview image corresponding to output data of a plurality of pages and display a preview image based on the image data, said computer program comprising steps of:
causing the computer to generate the image data in each page;
causing the computer to judge whether image data generation in each page is completed or not; and
causing the computer to display the preview image based on the image data whenever each image data is generated, according to the judging result in the judging step.

8. A non-transitory recording medium recording a computer program for causing a computer to generate image data for preview image corresponding to output data of a plurality of pages and display a preview image based on the image data, said computer program comprising steps of:
causing the computer to generate the image data in each page;
causing the computer to judge whether image data generation in each plurality of pages is completed or not; and
causing the computer to display a plurality of preview images based on a plurality of image data whenever the plurality of image data is generated, according to the judgment result in the judging step.
